(19) United States
(12) Patent Application Publication
(10) Pub. No.: US 2005/0015324 A1
(43) Pub. Date: Jan. 20, 2005

(54) Systems and methods for trading financial instruments across different types of trading platforms

(76) Inventors: Jacob Mathews, Kendall Park, NJ (US); Paul Mandel, Irvington, NY (US); Ilya Palatnik, Brooklyn, NY (US); Artur Muchnik, Gillette, NJ (US)

Correspondence Address: GEORGE D. MORGAN, ESQ;LOWENSTEINS SANDLER PC, 65 LIVINGSTON AVENUE, ROSELAND, NJ, 07068, US

(21) Appl. No.: 10/730,498

(22) Filed: Dec. 5, 2003

Related U.S. Application Data
(60) Provisional application No. 60/487,315, filed on Jul. 15, 2003.

(51) Int. Cl. G06F 17/60

(52) U.S. Cl. 705/37

(57) ABSTRACT

A plurality of trading platforms are communicatively linked. At least two of the trading platforms employ different protocols for exchanging trading information. An interface allows the trading platforms to share information regardless of protocol differences. An offering posted in one of the trading platforms can be simultaneously offered in all trading platforms, and a particular quantity of the offering can be purchased in any of the trading platforms.

### CROSS REFERENCE TO RELATED APPLICATIONS

This application claims the benefit of U.S. Provisional Application Ser. No. 60/487,315, filed by Mathews et al. on Jul. 15, 2003 and entitled “Systems and Methods For Trading Financial Instruments Across Different Types of Trading Platforms”, which is incorporated herein by reference.

### FIELD OF THE INVENTION

The present invention relates generally to trading financial instruments, and, more particularly, to systems and methods for trading financial instruments across different types of trading platforms.

### BACKGROUND OF THE INVENTION

Currently, if a client has a subscription to a trading platform where a particular financial instrument is being offered, the client can easily make a purchase. However, most clients do not have access to every type of trading platform. Thus, the client may not have access to the trading platform where the most suitable financial instrument is being offered.

Furthermore, dealers are often at a disadvantage because they can only offer a financial instrument through a particular trading platform. Thus, financial instruments are often offered to a limited client base. As a result, dealers cannot reach as many potential buyers as they would like. This makes it much more difficult for them to clear inventory and to serve clients' needs.

### SUMMARY OF THE INVENTION

A system for offering a financial instrument across different types of trading platforms includes a plurality of trading platforms, at least two of the trading platforms using different protocols for exchanging trading information, and an interface for linking the trading platforms to allow an offering posted in one of the trading platforms to be simultaneously offered in all of the trading platforms and a particular quantity of the offering to be purchased in any of the trading platforms.

A method for offering a financial instrument across different types of trading platforms, at least two of the trading platforms using different protocols for exchanging trading information, includes the steps of displaying an offering in one of the trading platforms, and offering the posted offering simultaneously in each of the other trading platforms, so as to allow a particular quantity of the offering to be purchased in any of the trading platforms.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating a system for trading financial instruments across trading platforms;

FIG. 2 illustrates a block diagram of an exemplary embodiment of the system shown in FIG. 1;

FIG. 3 illustrates an exemplary screen for displaying offerings entered by traders; and

FIGS. 4(a) and (b) illustrate exemplary screens for displaying quotes and making trades.

### DESCRIPTION OF PREFERRED EMBODIMENTS

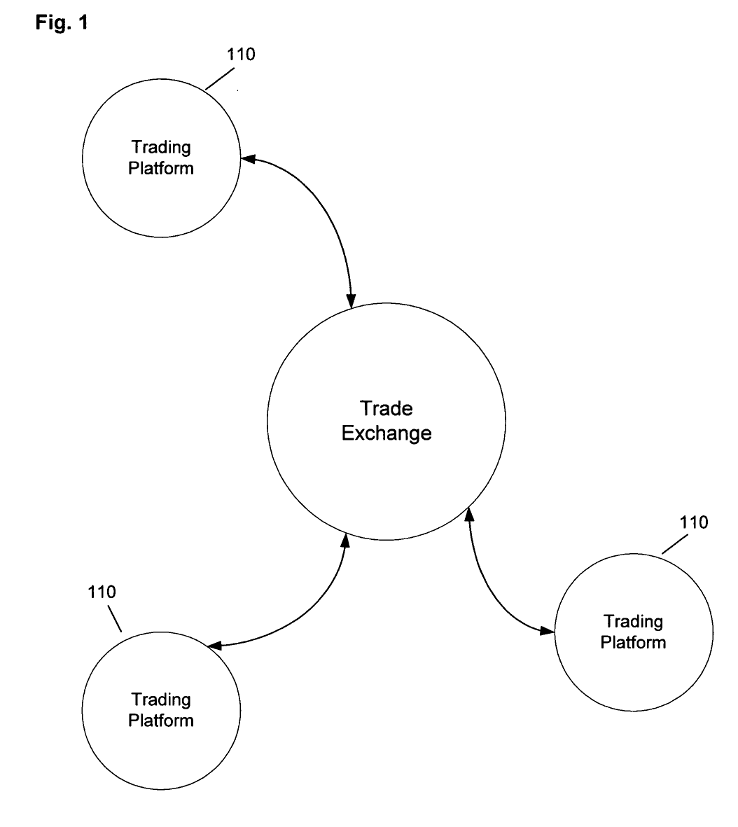

FIG. 1 illustrates an exemplary system for trading financial instruments across different types of trading platforms. As depicted in FIG. 1, a plurality of trading platforms 110 are connected to a Trade Exchange interface 150. In general, and as will be described in greater detail, this arrangement allows a financial instrument to be traded across any of the trading platforms 110.

Advantageously, the trading platforms 110 need not employ the same protocol for exchanging trading information. A trading protocol refers to the set of rules to enable computers to exchange trading information. In general, a trading platform 110 can communicate in any protocol understood by the Trade Exchange interface 150. When a trading platform 110 is added to the system, an adapter is preferably provided to allow the Trade Exchange interface 150 to translate messages to and from the added platform.

As a practical application, a source trading platform can include a risk management component. Other of the trading platforms can include trading portals. For example, offerings can be posted by a trader using a trade order management system (with risk management features) such as one available from BLOOMBERG LP. Any number of trading portals (e.g., TRADEWEB, MARKET AXESS) can also be connected to the system. The trading portals can be used to display quotes and make purchases.

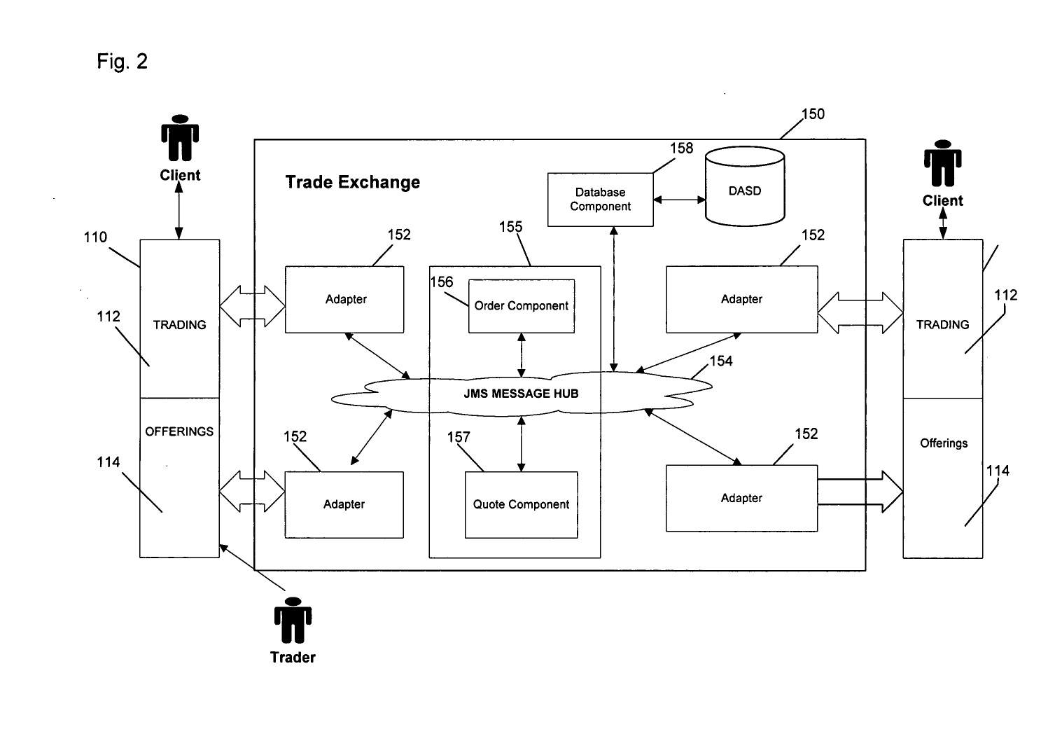

Referring to FIG. 2, a block diagram of an exemplary embodiment of the invention is shown. As depicted in FIG. 2, a system 200 includes two trading platforms 110 linked to the Trade Exchange interface 150. The trading platform 110 on the left-hand side of the diagram provides a mechanism for traders to post offerings. In this case this trading platform is the source trading platform. Although FIG. 2 depicts two trading platforms, any number of trading platforms 110 can be connected to the Trade Exchange interface 150.

The Trade Exchange interface 150 includes adapters 152 connected to each of the trading platforms 110. As shown, each of the trading platforms 110 includes a pair of adapters. For each of the trading platforms 110, one of the adapters translates trading information and the other translates offering information. “Trading information” refers to information related to a financial transaction. “Offering information” refers to information regarding a financial instrument being offered. “Translate” refers to interpreting a message according to a predetermined protocol and making it available in a understandable manner. It should be appreciated, however, that instead of a pair of adapters for each trading platform there alternatively may only be a single adapter for each trading platform performing the same functionality

Additionally, the Trade Exchange interface 150 includes an order/quote component 155 comprising an order component 156 for ensuring that all orders are properly made and a quote component 157 for ensuring that accurate quotation information is provided. The order component 156 and the quote component 157, as well as the adapters 152, are all connected to a JAVA (TM) messaging service (JMS) message hub 154. JMS allows the components of the system to provide a reliable, flexible service for the exchange of information. It should be appreciated, however, that other types of technology may be used without departing from the spirit and scope of the present invention.

Furthermore, a database component 158 can also be connected to the JMS message hub 154 to provide a way to trace the history of all transactions that occurred within a predetermined time period (e.g., day, week, month). The information may be stored in any suitable database and various reports (e.g., reconciliation, compliance) can be generated either in a predetermined manner or an ad hoc basis.

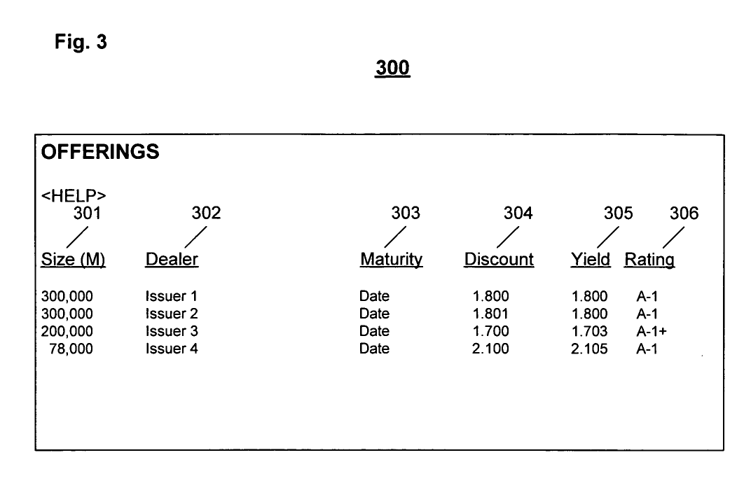

In an exemplary mode of operation, a trader inputs an offering into the source trading platform. FIG. 3 shows an exemplary embodiment of an offerings screen 300 usable to display offering information. The exemplary offerings screen 300 includes areas for displaying size 301, dealer 302, maturity 303, discount 304, yield 305, and rating 306 for several financial instruments. The information entered by the trader can be displayed using the offerings screen 300.

After being posted, the offering information is then sent to the Trade Exchange interface 150 as a quote message. The Trade Exchange interface 150 then translates the quote message to a format suitable for other trading platforms 110 (each having their own protocol) and transmits this information as a quote message to each of them. After receiving a quote message, the trading platform 110 preferably sends back a quote acknowledgment to the Trade Exchange interface 150. In this way, the Trade Exchange interface 150 can ensure that the trading platforms 110 are in agreement. Furthermore, whenever offering information changes, the Trade Exchange interface 150 can broadcast updated quotes to each of the trading platforms 110.

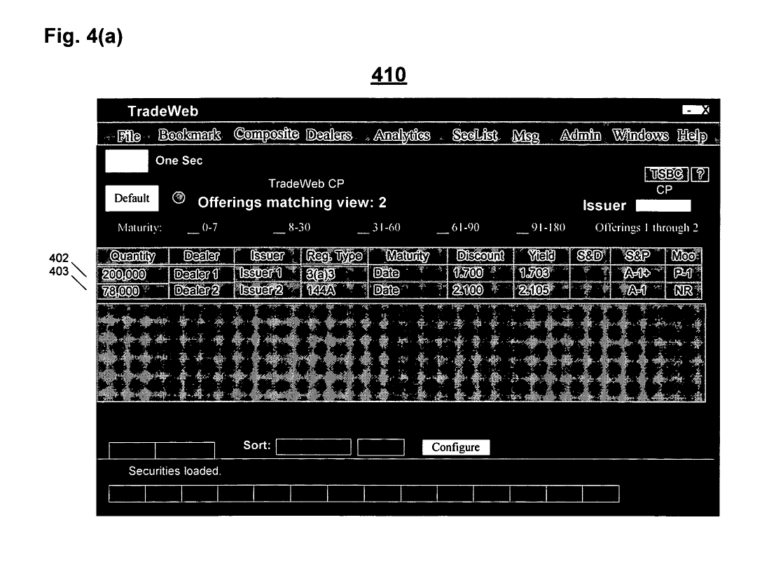

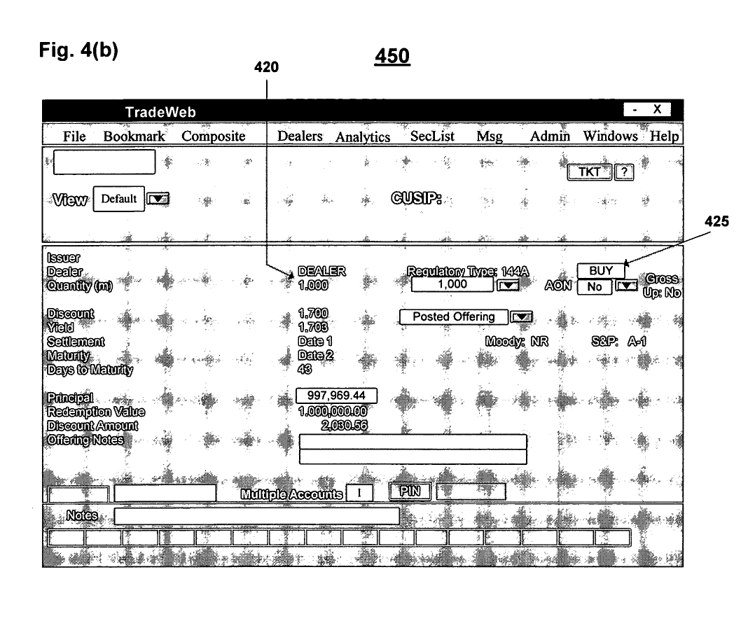

FIGS. 4(a) and (b) show exemplary screens for displaying quotes and making trades. As shown in FIG. 4(a), several financial instruments 402, 403 are displayed to a client using a screen 410. After the client selects a particular financial instrument from a list on the screen 410, another screen 450 is displayed, as shown in FIG. 4(b). As depicted in FIG. 4(b), the client has entered a quantity to be purchased in a text box 420 (i.e., 1,000) and can request an order by clicking the ‘Buy’ box 425. In this case, the client's trading platform (associated with this screen 450) generates an order request that is sent to the Trade Exchange interface 150. The Trade Exchange interface 150 then sends an order request acknowledgment back to the client's trading platform and an order request to the source trading platform 110.

After receiving the order request the source trading platform 110 sends an order request acknowledgment to the Trade Exchange interface 150. The source trading platform 110 also sends an order response (with a ticket number) to the Trade Exchange interface 150 within a predetermined time period. If received in a timely manner, the Trade Exchange interface 150 then routes the order response to the client's trading platform 110.

After receiving the order response, the client's trading platform 110 sends an order response acknowledgment and a trade check message to the Trade Exchange interface. The Trade Exchange interface 150 then sends back a trade check response indicating that the trade was successful. The client's trading platform 110 then sends back a trade check acknowledgment and a trade end message. The Trade Exchange interface 150 then sends back a trade end acknowledgment.

Because the quantity of the offering has been reduced as a result of the trade, the source trading platform must now provide an updated quote message with the correct offering information to the Trade Exchange interface 150. After receiving the updated quote message, the Trade Exchange interface 150 then routes the updated quote information to all of the trading platforms 110 to ensure integrity of the pricing information.

The invention will be further clarified by the following examples:

### EXAMPLE 1

Secondary Instrument Quote and Immediate Order Flows

The instrument being offered is a UBS Finance Commercial Paper Issue. The trader is offering 1M nominal, at a rate of 1.3 percent. The issue matures on Apr. 7, 2003. The trade and settlement date is Mar. 26, 2003. The issue date was Jan. 7, 2003.

This offering is posted on a Bloomberg LP trading platform and both the Bloomberg LP trading platform and a TradeWeb trading platform are connected to the Trade Exchange interface. The following are some typical conversational flows.
1. Bloomberg: quote message→Trade Exchange
2. Trade Exchange: quote message→TradeWeb
3. TradeWeb: quote acknowledgment→Trade Exchange
4. TradeWeb: order request→Trade Exchange
5. Trade Exchage: order request acknowledgment→TradeWeb
6. Trade Exchange: order request→Bloomberg
7. Bloomberg: order acknowledgment→Trade Exchange
8. Bloomberg: order response (with ticket number)→Trade Exchange
9. Trade Exchange: order response (“deal is done”)→TradeWeb
10. TradeWeb: order response acknowledgment→Trade Exchange
11. TradeWeb: trade check message→Trade Exchange
12. Trade Exchange: trade check response (“trade done”)→TradeWeb
13. TradeWeb: trade check response acknowledgment→Trade Exchange
14. TradeWeb: trade end message→Trade Exchange
15. Trade Exchange: trade end acknowledgment→TradeWeb
16. Bloomberg: quote message (updated)→Trade Exchange
17. Trade Exchange: quote message (updated)→TradeWeb
   Note: Since the original quoted amount was fully traded, zero remains, and the message contains an request to delete the quote from Trade Web.
18. TradeWeb: quote message acknowledgment→Trade Exchange

### EXAMPLE 2

Primary Instrument (with Maturity Ranges) Quote and Immediate Order Flows

The instrument is a Kraft Commercial Paper Issue. The trader is offering 10M nominal, at a rate of 1.28 percent. The issue matures between Mar. 27, 2003 and Mar. 28, 2003. The trade and settle date is Mar. 26, 2003. The issue date was Mar. 26, 2003.

This offering is posted on a Bloomberg LP trading platform and both the Bloomberg LP trading platform and a TradeWeb trading platform are connected to the Trade Exchange interface. The following are some typical conversational flows.
1. Bloomberg: quote message→Trade Exchange
2. Trade Exchange: quote message→TradeWeb
3. TradeWeb: quote message acknowledgment→Trade Exchange
4. TradeWeb: order request→Trade Exchange
5. Trade Exchange: order request acknowledgment→TradeWeb
6. Trade Exchange: order request→Bloomberg
7. Bloomberg: order request acknowledgment→Trade Exchange
8. Bloomberg: order response (ticket number)→Trade Exhange
9. Trade Exchange: dealer response (“deal is done”)→TradeWeb
10. TradeWeb: dealer response acknowledgment→Trade Exchange
11. TradeWeb: trade check message→Trade Exchange
12. Trade Exchange: trade check response (“trade done”)→TradeWeb
13. TradeWeb: trade check response acknowledgment→Trade Exchange
14. TradeWeb: trade end message→Trade Exchange
15. Trade Exchange: trade end acknowledgment→TradeWeb
16. Bloomberg: quote message (updated)→Trade Exchange
17. Trade Exchange: quote message (updated)→TradeWeb
19. Trade Exchange: quote message (updated)→TradeWeb
   Note: Since the original quoted amount was fully traded, zero remains, and the message contains an request to delete the quote from Trade Web.
20. TradeWeb: quote message acknowledgment→Trade Exchange

### EXAMPLE 3

Primary Instrument (with Series of Maturity Ranges) Quote and Subject Order Flows

The instrument is a UBN Delaware Commercial Paper issue. The trader is offering 500M nominal. There are three series of maturity ranges.
First series matures between Apr. 14, 2003 and Apr. 15, 2003, at a rate of 1.70
Second series matures between Apr. 10, 2003 and Apr. 11, 2003, at a rate of 1.6
Third series matures between Apr. 8, 2003 and Apr. 9, 2003, at a rate of 1.5

The issue trade and settle date is Apr. 7, 2003. The issue date was Apr. 7, 2003.

This offering is posted on a Bloomberg LP trading platform and both the Bloomberg LP trading platform and a TradeWeb trading platform are connected to the Trade Exchange interface. The following are some typical conversational flows.
1. Bloomberg: quote message→Trade Exchange
2. Trade Exchange: quote message (first maturity range)→TradeWeb
3. TradeWeb: quote message acknowledgment→Trade Exchange
4. Trade Exchange: quote message (second maturity range)→TradeWeb
5. TradeWeb: quote message acknowledgment→Trade Exchange
6. Trade Exchange: quote message (third maturity range)→TradeWeb
7. TradeWeb: quote message acknowledgment→Trade Exchange
8. TradeWeb: order request→Trade Exchange
9. Trade Exchange: order request acknowledgment→TradeWeb
10. Trade Exchange: Query to dealer to accept or decline order.
   Note: This will cause the order to be routed to the relevant trader and a pop-up will appear on his or her desktop, with a timer requiring acceptance during a particular time period.
11. TradeWeb: dealer response acknowledgment→Trade Exchange
12. TradeWeb: dealer acceptance message→Trade Exchange
13. Trade Exchange: order request→Bloomberg
14. Bloomberg: order request acknowledgment→Trade Exchange
15. Bloomberg: order response (ticket number)→Trade Exchange
16. Trade Exchange: trade check response (“trade done”)→TradeWeb
17. TradeWeb: trade check response acknowledgment→Trade Exchange
18. TradeWeb: trade end message→Trade Exchange
19. Trade Exchange: trade end acknowledgment→TradeWeb
20. Bloomberg: quote message (updated)→Trade Exchange

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A system for offering a financial instrument across different types of trading platforms, comprising:
a plurality of trading platforms, at least two of the trading platforms using different protocols for exchanging trading information; and
an interface for linking the trading platforms to allow an offering posted in one of the trading platforms to be simultaneously offered in each of the trading platforms and a particular quantity of the offering to be purchased in any of the trading platforms.

2. The system of claim 1, wherein the interface generates an acknowledgment message when a trading request is received.

3. The system of claim 2, wherein the acknowledgment message is generated after receipt of a trading request to purchase a specified quantity of a specified financial instrument at a specified price.

4. The system of claim 2, wherein a trade is canceled if the acknowledgment message is not received within a predetermined time period.

5. The system of claim 1, wherein a first trading platform includes a risk management component and a second trading platform includes a trading portal.

6. The system of claim 1, further including a reporting component for reporting transaction information associated with trading activity.

7. The system of claim 1, wherein the interface includes an adapter for each of the trading platforms, each of the adapters allowing the interface to translate messages to and from one of the trading platforms.

8. The system of claim 1, wherein the interface ensures that offering information is uniform in each of the trading platforms.

9. The system of claim 8, wherein a change of pricing information in one of the trading platforms causes a corresponding pricing information change in other of the trading platforms.

10. The system of claim 8, wherein a change of quantity information in one of the trading platforms causes a corresponding quantity information change in other of the trading platforms.

11. A method for offering a financial instrument across different types of trading platforms, at least two of the trading platforms using different protocols for exchanging trading information, comprising the steps of:
posting an offering in one of the trading platforms; and
displaying the posted offering simultaneously in each of the other trading platforms, so as to allow a particular quantity of the offering to be purchased in any of the trading platforms.

12. The method of claim 11, further including the step of generating an acknowledgment message when a trading request is received.

13. The method of claim 12, wherein the acknowledgment message is generated after receipt of a trading request to purchase a specified quantity of a specified financial instrument at a specified price.

14. The method of claim 12, wherein a trade is canceled if the acknowledgment message is not received within a predetermined time period.

15. The method of claim 11, wherein a first trading platform includes a risk management component and a second trading platform includes a trading portal.

16. The method of claim 11, further including the step of reporting transaction information associated with trading activity.

17. A program storage device readable by a machine, tangibly embodying a program of instructions executable on the machine to perform method steps for offering a financial instrument across different types of trading platforms, at least two of the trading platforms using different protocols for exchanging trading information, the method steps comprising:
posting an offering in one of the trading platforms; and
displaying the posted offering simultaneously in each of the other trading platforms, so as to allow a particular quantity of the offering to be purchased in any of the trading platforms.
